(19) United States
(12) Patent Application Publication
(10) Pub. No.: US 2023/0202680 A1
(43) Pub. Date: Jun. 29, 2023

(54) Versatile Hybrid Drone and Nest System

(71) Applicant: ABDALLAH YEHYA, Doha (QA)

(72) Inventor: ABDALLAH YEHYA, Doha (QA)

(21) Appl. No.: 17/561,765

(22) Filed: Dec. 24, 2021

(51) Int. Cl. B64F 1/00; B64C 39/02; B60L 53/51

(52) U.S. Cl. CPC B64F 1/007; B64C 39/024; B60L 53/51; B64C 2201/021; B64C 2201/088; B64C 2201/201; B64C 2201/042; B64C 2201/123

(57) ABSTRACT

The present disclosure provides a versatile drone and nest launching system. A hybrid UAV drone having fixed wings in addition to vertical take-off and landing capabilities is used to enable the launching nest to remain compact and of simple design with few moving parts, while also housing a drone capable of travelling long distances. The entire system is configured function autonomously, utilising a solar-powered charging pad installed on the nest to repeatedly recharge and relaunch depleted drones. Novel mounting systems for situating the nest in a variety of terrains are also disclosed.

### FIELD OF INVENTION

The present invention relates generally to the field of drone or UAV (unmanned aerial vehicle) technology. More specifically, the present invention relates to an autonomous drone and nest system for launching and landing the drone in between operations.

### BACKGROUND

The term Unmanned Aerial Vehicle (UAV) refers to an aircraft without a human pilot aboard, often also called a drone. Such UAVs often have an onboard computer for controlling flight, or a wireless transceiver for receiving instructions from a pilot to remotely control the flight of the UAV. The UAV is often used in situations where manned flight is considered too risky or difficult.

Autonomous control is increasingly being employed in UAVs, and modern UAVs are able to transmit large amounts of data, such as live video, to remote locations. Such UAVs can autonomously perform military reconnaissance as well as strike missions, and can also be used for civil applications, such as nonmilitary security work, e. g., surveillance of pipelines.

There are a wide variety of UAV shapes, sizes, configurations, and characteristics. For example, miniature and micro-UAV systems can use either fixed wing or rotary-wing configurations. Fixed wing UAVs have a much greater flight range, but are unable to perform the vertical take-off and landing operations that rotary wing UAVs can, instead requiring a runway or human assistance. Hybrid UAVs also exist which take advantage of both mechanisms, switching between propulsion mechanisms for the take-off and landing operations.

Extensive human interaction or setup is often required to prepare for launch, get the UAV airborne and fly the UAV, either locally or remotely, out to radio frequency (RF) line-of-sight ranges. The UAVs generally return to the same location for landing from which they were launched so that the human operators can recover the UAVs and repair and/or prepare them for another flight. Typical launch methods for fixed-wing UAVs can include human-powered launch by hand, or on a rail system typically powered by pneumatic, pyrotechnic, elastomeric (“bungee cord”), or electromagnetic subsystems. Both basic methods of launch require operator interaction to prepare the launcher as well as the UAV, with pre-flight checks, for example.

In order to increase the autonomy of UAV flight operations, UAV “nest” stations have been developed, which act as both hangars and launchpads, assisting with take-off and landing operations, recharging the UAVs, and storing them when not in use. While solving many problems, these UAV nests are often bulky and complex, with many moving parts. This is in part because they are designed to handle the launch of different types of UAVs.

It would be desirable for a UAV nest and drone system to be built in a more compact manner, relying on the vertical take-off and landing capabilities of hybrid-type UAV drones. It is within this context that the present invention is provided.

### SUMMARY

The present disclosure provides a versatile drone and nest launching system. A hybrid UAV drone having fixed wings in addition to vertical take-off and landing capabilities is used to enable the launching nest to remain compact and of simple design with few moving parts, while also housing a drone capable of travelling long distances. The entire system is configured function autonomously, utilising a solar-powered charging pad installed on the nest to repeatedly recharge and relaunch depleted drones. Novel mounting systems for situating the nest in a variety of terrains are also disclosed.

Thus, according to one aspect of the present disclosure there is provided an autonomous drone and nest system, comprising: a hybrid UAV drone, comprising: an elongated body having a central axis; a set of fixed wings disposed either side of the body; a power source, one or more sensors, wireless transceiver, and controller; a plurality of front rotors affixed to each of the wings and each oriented to rotate about an axis parallel to the central axis; and at least one rear rotor attached to a rearward tail portion of the body, wherein the rear rotor is configured to move between a first position in which the rear rotor is aligned with the plurality of front rotors, contributing to a forward thrust of the drone, and a second position in which the rear rotor is oriented to rotate about a vertical axis perpendicular to the central axis, contributing to a downward thrust to facilitate vertical take-off and landing.

The system further comprises a nest, comprising: a container configured to support and enclose the hybrid UAV drone, an upper portion of the container comprising one or more doors configured to open and close to facilitate vertical take-off and landing of the hybrid UAV drone; a power source, charging pad, wireless transceiver, and a nest controller each disposed within the container; a wind meter disposed, one or more solar panels, and camera disposed atop the container; wherein the nest controller is configured to communicate with the drone controller and operate the one or more container doors to coordinate launching and landing operations of the hybrid UAV drone, and to use the camera and wind meter to check positioning and environmental conditions of the drone during both take-off and landing.

In some embodiments, the nest is mounted atop a plurality of leg supports.

Furthermore, each of the leg supports may connect to the nest by a slidable bearing, allowing for adjustment to accommodate uneven terrain.

In other embodiments, the nest is mounted atop a tall pole.

In some embodiments, solar panels are the sole power source of the nest.

In some embodiments, the nest controller is configured to check the windmeter and camera prior to opening the one or more doors to determine whether environmental conditions are suitable for a launch operation of the hybrid UAV drone.

In some embodiments, the interior of the container is equipped with a docking station configured to replace a depleted power source of the hybrid UAV drone with a fully charged power source from the charging pad.

In some embodiments, the container and the one or more doors of the container are sized to be compact whilst ensuring the hybrid UAV drone has sufficient space for launching and landing operations.

In some embodiments, the controller of the hybrid UAV drone and the nest controller communicate to allow the drone to perform survey operations of an area within a certain radius of the nest in an autonomous fashion, with the drone returning to the nest to have the power source replaced or recharged periodically.

In some embodiments, the nest controller is further configured to carry out directional signal tracking of the hybrid UAV drone to increase the range.

In some embodiments, the nest controller is further configured to store survey data received from the hybrid UAV drone and to transmit the survey data to an external device.

Furthermore, the survey data may comprise a live video or sensor feed from the drone.

In some embodiments, the one or more sensors of the hybrid UAV drone comprise one or more of a camera, an IR camera, a thermal camera, an accelerometer and a GPS unit.

In some embodiments, the system comprises multiple nests and drone pairs configured to perform operations in coordination with one another over a geographical area.

In some embodiments, the interior of the container further comprises a repositioning mechanism to centre the drone within the container following each landing operation.

### BRIEF DESCRIPTION OF THE DRAWINGS

Various embodiments of the invention are disclosed in the following detailed description and accompanying drawings.

FIG. 1 illustrates an isometric view of a UAV nest station according to the present disclosure with its enclosure doors in a closed position.

FIG. 2 illustrates a second isometric view of the UAV nest station with one enclosure door in an open position to partially reveal an interior of the enclosure.

FIG. 3 illustrates a first isometric view of a hybrid type UAV drone according to the present disclosure for use with the UAV nest station.

FIG. 4 illustrates a second isometric view of the hybrid type UAV drone according to the present disclosure.

FIG. 5 illustrates an isometric view of the UAV nest station deployed on a versatile all-terrain mounting system.

FIG. 6 illustrates an isometric view of the UAV nest station deployed on an alternative protective mounting system.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present disclosure provides a compact design for an autonomous drone and nest system. The UAV drone enclosed within the nest housing is a hybrid type drone, capable of both fixed wing flight and vertical landing and take-off, this allows the nest enclosure to be built with few moving parts, requiring no internal platform to be raised for take-off and landing, the doors of the enclosure opening (which itself only need be large enough to allow the UAV to pass through) are opened and the drone enters or leaves and then switches to fixed wing flight.

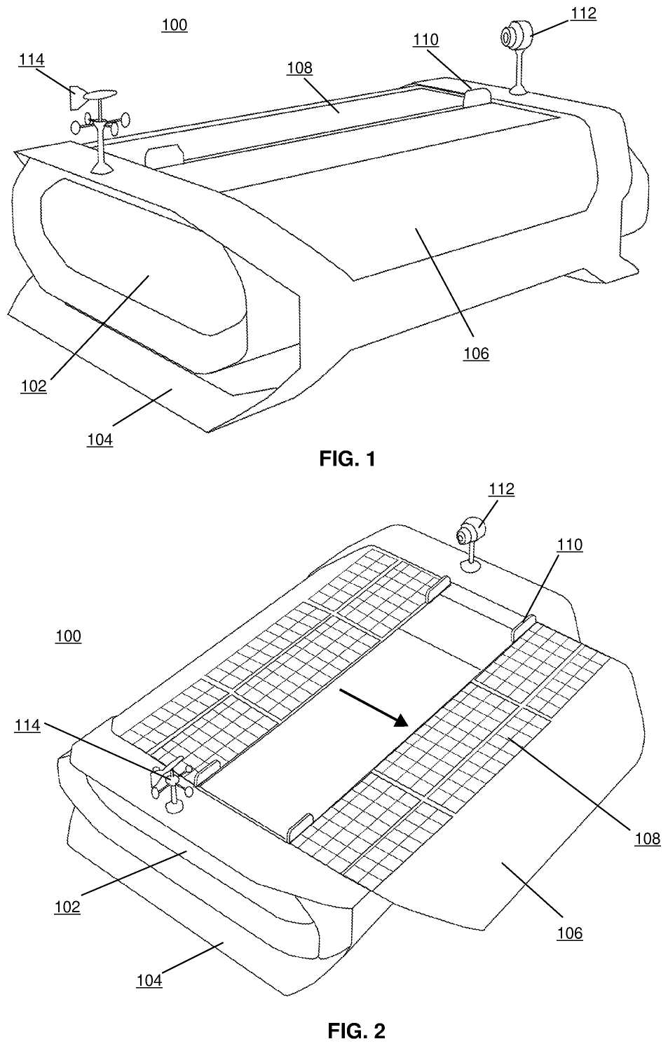

Referring to FIG. 1 and FIG. 2, an example nest configuration 100 is shown isometrically.

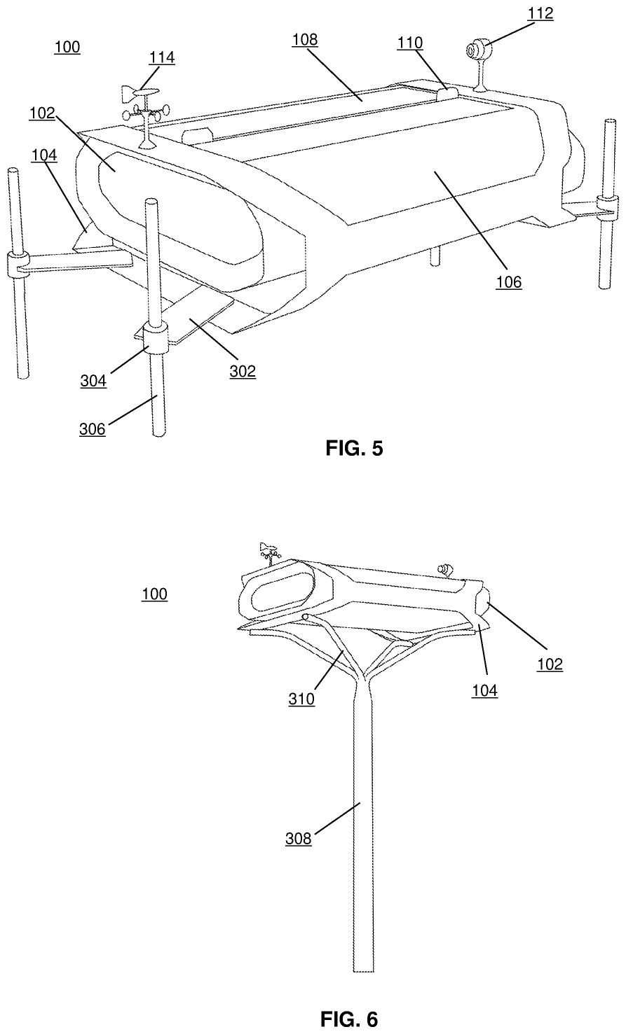

As can be seen, the nest 100 of the present example comprises a flattened enclosure 102 in the shape of a rounded box. Although not illustrated, enclosure 102 may take other suitable shapes. The enclosure 102 is held within a mounting frame 104, which both serves to protect the enclosure 102 against vibrations and impacts, and also allows the system to be attached to various mounting gear as will be described below (see FIGS. 5 and 6).

The top of the enclosure 102 comprises an opening spanning the entire width and most of the length of the enclosure, with a set of computer-controlled doors 106 covering the opening and being configured to move between an open and close position to allow a UAV stored within the enclosure to enter or leave—see FIG. 2 where one of the doors 106 is shown slid to the open position. In the present example, each of the doors 106 is mounted on a set of rails internal to the enclosure and thus configured to slide between the open and closed positions.

In order to increase the autonomy of the nest 100, a plurality of solar panels 108 are mounted atop each of the sliding doors 106. The solar panel array is coupled to an internally housed power source of the nest 100, allowing for the nest to function for extended periods of time without human contact. The power source is coupled to a microcontroller, also internally disposed, which controls the operations of the nest, including the movement of the doors 106 along their rails.

The sliding doors 106 may also be provided with one or more separating tabs 110 at their meeting surfaces to prevent jamming and cushion the doors 106 from one another.

The nest 100 also comprises a camera 112 such as a CCTV camera, disposed atop the nest and oriented to have a clear view of take-off and landing operations of a drone as it leaves or enters the enclosure 102. The camera 112 is coupled to the controller, allowing the controller to both determine environmental conditions surrounding the nest 100 prior to launch or landing and to calibrate the position of a UAV drone entering or leaving and, if necessary, communicate with it to adjust its positioning. The controller also has access to a wireless transceiver for this purpose, allowing communication with a paired UAV drone over both short and long distances.

The nest 100 also comprises one or more sensors for checking environmental conditions surrounding it, including at least wind meter 114, and optionally including one or more other sensors such as temperature and humidity sensors. If the controller, by monitoring camera 112 and the one or more sensors 114, determines that conditions are not suitable for take-off or landing, the controller may delay such operations until environmental conditions become suitable. In extreme cases where the UAV drone needs to land and recharge but is prevented from doing so by the conditions, the controller may instruct the UAV drone to travel to an alternative landing site/nest.

Although not illustrated, the nest is also provided with an internal docking and recharging station for paired UAVs. This may consists simply of a wireless charging pad for recharging a battery of the UAV in between flight operations, or may comprise a more complex arrangement capable of removing spent batteries from the UAV upon return from an operation and replacing them with batteries that have been charged by the nest in the interim, allowing in some cases for immediate relaunch.

The docking station may comprise other functionality such as a recentring mechanism to ensure the UAV launches from a consistent position within the enclosure 102 each time, regardless of where it lands within the enclosure.

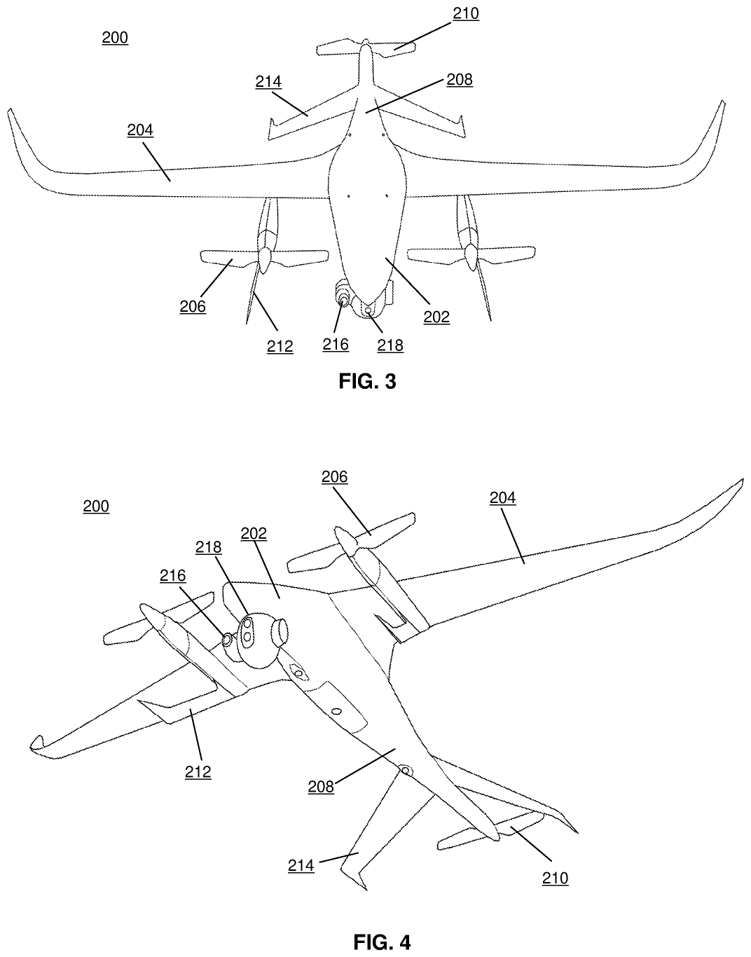

Turning to FIGS. 3 and 4, an example configuration of a hybrid UAV drone 200 for use in conjunction with the nest 100 of the present disclosure is shown.

As can be seen, the drone 200 has a fixed wing configuration, with a central elongated body 202 disposed between the two fixed wings 204. Each wing 204 has at least one forward thrust rotor 206 angled to generate thrust along the axis of the elongated body. The body 202 ends in a rear tail portion 208 which has affixed thereon at least one rear rotor 210.

The rear rotor 210 must be configured to change orientation between the shown position, where it is aligned with and thus generates thrust along the same axis as the forward rotors 206, and a second position used for vertical take-off and landing operations where it generates downward thrust along the vertical axis. This may be achieved by the configuration of the bearing on which the rotor 210 itself is mounted or by having the rear tail portion 208 of the UAV configured to fold 90 degrees.

In some examples the forward rotors 206 may be configured in the same manner, moving between forward thrust position and downward thrust position. This would allow greater power and control over the total downward thrust generated by the UAV during landing and take-off.

In order to maintain stability of the UAV drone 200, both front stabilisers 212 and rear stabilisers 214 are provided on the aircraft. This both assists with long haul flights and prevents turbulence during the transition from take-off and landing operations and fixed wing flight from destabilising the vehicle too fast.

The UAV drone 200 is provided with a camera 216 and multiple other sensors 218 as is standard for such vehicles and is known in the art. These may include but are not limited to an IR camera, a thermal camera, an accelerometer and a GPS unit.

Each of the above sensors, as well as the front and rear rotors and the bearings on which at least the rear rotor changes orientation, are coupled to a UAV controller. The UAV controller comprises a wireless transceiver that allows for short range and long range communication with the paired nest and enables regular drone operations such as surveying to be carried out by the drone 200. Live video and other survey data can be streamed back to the nest 100 during an operation, or in some examples the data may be stored on a storage unit of the UAV during flight and only transferred to the nest 100 upon landing.

The drone and nest pair may communicate with a remote base station that acts as a headquarters, and may even be part of a network of paired nests and drones operating in coordination to survey or reconnaissance a geographical area.

Referring to FIGS. 5 and 6, two variations of mounting system for the drone and nest system 100 are shown.

The purpose of the disclosed system is generally to autonomously survey and monitor geographical areas which are remote or dangerous for human monitoring, reducing danger to human operators. As such, it is desirable to be able to place the nest 100 which acts as the base of operations for the drone 200 on terrain for all types, and out of reach of interference.

FIG. 5 shows a first mounting system comprising a set of four leg attachments 302 which connect the mounting frame 104 of the nest to slidable bearings 304 through which poles 306 of various lengths are disposed. The connections between the bearings 304 and the attachments 302 may be adjustable in angle, which in combination with the ability of the poles 306 to slide through the bearings, allows for the nest to be supported on practically any surface by angling each pole to rest against a suitable point of contact.

FIG. 6 shows a second mounting system, comprises a tall pole 308 and a set of supports 310 connecting the pole 308 and the mounting frame 104 of the nest. This mounting system is specifically designed to prevent interference and damage to the nest 100 by animals or humans in the area in which it is surveying.

The wireless communications include, by way of example and not of limitation, CDMA, WCDMA, GSM, UMTS, or any other wireless communication system such as wireless local area network (WLAN), Wi-Fi or WiMAX.

It should be understood that the operations described herein, in particular the communications between nest systems 100 and exterior devices such as base stations, may be carried out by any processor. In particular, the operations may be carried out by, but are not limited to, one or more computing environments used to implement the method such as a dedicated hosting environment, and/or one or more other computing environments in which one or more assets used by the method re implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the drone and nest system have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An autonomous drone and nest system, comprising:
a hybrid UAV drone, comprising:
an elongated body having a central axis;
a set of fixed wings disposed either side of the body;
a power source, one or more sensors, wireless transceiver, and controller;
a plurality of front rotors affixed to each of the wings and each oriented to rotate about an axis parallel to the central axis; and
at least one rear rotor attached to a rearward tail portion of the body, wherein the rear rotor is configured to move between a first position in which the rear rotor is aligned with the plurality of front rotors, contributing to a forward thrust of the drone, and a second position in which the rear rotor is oriented to rotate about a vertical axis perpendicular to the central axis, contributing to a downward thrust to facilitate vertical take-off and landing;
and
a nest, comprising:
a container configured to support and enclose the hybrid UAV drone, an upper portion of the container comprising one or more doors configured to open and close to facilitate vertical take-off and landing of the hybrid UAV drone;
a power source, charging pad, wireless transceiver, and a nest controller each disposed within the container;
a wind meter disposed, one or more solar panels, and camera disposed atop the container;
wherein the nest controller is configured to communicate with the drone controller and operate the one or more container doors to coordinate launching and landing operations of the hybrid UAV drone, and to use the camera and wind meter to check positioning and environmental conditions of the drone during both take-off and landing.

2. A system according to claim 1, wherein the nest is mounted atop a plurality of leg supports.

3. A system according to claim 2, wherein each of the leg supports connects to the nest by a slidable bearing, allowing for adjustment to accommodate uneven terrain.

4. A system according to claim 1, wherein the nest is mounted atop a tall pole.

5. A system according to claim 1, wherein solar panels are the sole power source of the nest.

6. A system according to claim 1, wherein nest controller is configured to check the windmeter and camera prior to opening the one or more doors to determine whether environmental conditions are suitable for a launch operation of the hybrid UAV drone.

7. A system according to claim 1, wherein the interior of the container is equipped with a docking station configured to replace a depleted power source of the hybrid UAV drone with a fully charged power source from the charging pad.

8. A system according to claim 1, wherein the container and the one or more doors of the container are sized to be compact whilst ensuring the hybrid UAV drone has sufficient space for launching and landing operations.

9. A system according to claim 1, wherein the controller of the hybrid UAV drone and the nest controller communicate to allow the drone to perform survey operations of an area within a certain radius of the nest in an autonomous fashion, with the drone returning to the nest to have the power source replaced or recharged periodically.

10. A system according to claim 1, wherein the nest controller is further configured to carry out directional signal tracking of the hybrid UAV drone to increase the range.

11. A system according to claim 1, wherein the nest controller is further configured to store survey data received from the hybrid UAV drone and to transmit the survey data to an external device.

12. A system according to claim 11, wherein the survey data comprises a live video or sensor feed from the drone.

13. A system according to claim 1, wherein the one or more sensors of the hybrid UAV drone comprise one or more of a camera, an IR camera, a thermal camera, an accelerometer and a GPS unit.

14. A system according to claim 1, wherein the system comprises multiple nests and drone pairs configured to perform operations in coordination with one another over a geographical area.

15. A system according to claim 1, wherein the interior of the container further comprises a repositioning mechanism to centre the drone within the container following each landing operation.
